(19) United States
(12) Patent Application Publication
(10) Pub. No.: US 2026/0070743 A1
(43) Pub. Date: Mar. 12, 2026

(54) TRANSFER SYSTEM, CONTROL METHOD OF TRANSFER SYSTEM, AND PROGRAM STORED IN RECORDING MEDIUM

(71) Applicant: SEMES CO., LTD., Cheonan-si (KR)

(72) Inventor: Kyu Hyung PARK, Suwon-si (KR)

(73) Assignee: SEMES CO., LTD., Cheonan-si (KR)

(21) Appl. No.: 19/320,025

(22) Filed: Sep. 5, 2025

(30) Foreign Application Priority Data
Sep. 6, 2024 (KR) 10-2024-0121504

(51) Int. Cl. B65G 43/10; B65G 47/70

(52) U.S. Cl. CPC B65G 43/10; B65G 47/70

(57) ABSTRACT

Provided is a method of controlling a transfer system. The method includes: collecting traveling information obtained while a transfer unit travels along a rail installed on the manufacturing line; and based on the traveling information, controlling a direction of at least one switching unit included in the rail, in which the switching unit switches a lane on which the transfer unit travels.

### CROSS-REFERENCE TO RELATED APPLICATION

This application claims priority to and the benefit of Korean Patent Application No. 10-2024-0121504 in the Korean Intellectual Property Office on Sep. 6, 2024, the entire contents of which are incorporated herein by reference.

### TECHNICAL FIELD

The present invention relates to a transfer system, a control method of a transfer system, and a control method of a switching unit, and more specifically, to a transfer system that transfers an article in a manufacturing line, a control method of a transfer system, and a program stored in a recording medium.

### BACKGROUND ART

The semiconductor manufacturing process is very complex and requires a precise process. Efficient transfer of wafers between various process equipment in a semiconductor manufacturing line is very important for productivity improvement and cost reduction. To this end, various transfer systems are being developed, and among them, the Overhead Hoist Transfer System (hereinafter referred to as the OHT system) is widely used as a key transfer device in semiconductor manufacturing lines.

The OHT system transfers containers, such as a Front Opening Unified Pod (POUP) to semiconductor manufacturing equipment as a transfer vehicle travels along the rail installed on the ceiling of the semiconductor manufacturing line. The FOUP is a container for accommodating wafers and is used to protect and transfer wafers during semiconductor manufacturing processes. The OHT system increases the efficiency of the manufacturing process by moving these FOUPs quickly and safely.

In general, the rail of the OHT system has various branch points, and the branch rail is used in the branch point. The branch rails allow the transfer vehicle to maintain the existing traveling lane or change the traveling path to move to another lane. These branch rails provide flexibility in the manufacturing process and allow the FOUP to be accurately moved to the desired location through various routes.

In the branch rails used in the existing OHT system, lane changing is implemented in only one direction (uni-direction). For example, in the branch rail, the transfer vehicle can change the lane from the first lane to the second lane, but cannot change the lane from the second lane to the first lane. This restriction hinders the flexibility of the manufacturing process.

In particular, in order to change the lane from the second lane to the first lane, another branch rail must be additionally installed. This not only consumes additional costs, but also has a problem in that it is difficult to install a branch rail in a small space area. These problems reduce the efficiency of the OHT system and interfere with the optimization of the semiconductor manufacturing process.

Therefore, to solve this problem, the present invention proposes an OHT transfer system capable of changing lanes in both directions and a control method thereof. Through this, the present invention aims to overcome the limitations of the existing one-directional branch rail and implement a more flexible and efficient semiconductor manufacturing process transfer system.

### SUMMARY OF THE INVENTION

The present invention has been made in an effort to provide a transfer system capable of improving the efficiency of transferring an article in a manufacturing line, a control method of the transfer system, and a program stored in a recording medium.

The present invention has also been made in an effort to provide a transfer system capable of changing a traveling lane of a transfer unit in both directions, a control method of the transfer system, and a program stored in a recording medium.

The present invention has also been made in an effort to provide a transfer system capable of improving the traveling efficiency of a transfer unit by setting a switching direction of the transfer unit based on traveling information of the transfer unit, a control method of the transfer system, and a program stored in a recording medium.

The objectives of the present disclosure are not limited thereto and other objectives not stated herein may be clearly understood by those skilled in the art from the following description.

An exemplary embodiment of the present disclosure, a method of controlling a transfer system that transfers an article within a manufacturing line, the method comprising: collecting traveling information obtained while a transfer unit travels along a rail installed on the manufacturing line; and based on the traveling information, controlling a direction of at least one switching unit included in the rail, in which the switching unit may switches a lane on which the transfer unit travels.

According to the exemplary embodiment of the present invention, the traveling information is collected by the sensor, and is information about whether the transfer unit is to enter a switching zone where the switching unit is provided and is entering the switching zone, and, the controlling of the direction of the switching unit may include changing the direction of the switching unit prior to a set time before the transfer unit enters the switching unit.

According to the exemplary embodiment of the present invention, a switching time required for the switching unit to change the direction may be shorter than the set time.

According to the exemplary embodiment of the present invention, the method may further include allocating a task to the transfer unit; and deriving a traveling path of the transfer unit based on the allocated task and checking whether the switching unit exists on the derived traveling path.

According to the exemplary embodiment of the present invention, the controlling of the direction of the switching unit may include presetting the direction of the switching unit according to the traveling path when the switching unit exists on the traveling path.

According to the exemplary embodiment of the present invention, the collecting of the traveling information may be performed after the presetting of the direction of the switching unit and before the changing of the direction of the switching unit.

According to the exemplary embodiment of the present invention, the method may further include the direction is not changed in the changing of the direction of the switching unit, re-searching a new traveling path to enable the task of the transfer unit to be performed.

According to the exemplary embodiment of the present invention, the traveling information is collected by a control system that controls the transfer unit, and may be information on a direction statistical value, which are usage by the transfer unit for each direction of the transfer unit for a certain period of time while the switching unit operates in a constant driving mode.

According to the exemplary embodiment of the present invention, the method may further controlling the direction of the switching unit based on the direction statistical value, wherein the direction of the switching unit may be maintained until it is confirmed that a quantity of the manufacturing line is changed.

According to the exemplary embodiment of the present invention, the switching to the constant driving mode for collecting the direction statistical value may takes place when the control system checks whether a quantity of the manufacturing line changes every preset cycle and the quantity is changed.

According to the exemplary embodiment of the present invention, the switching to the constant driving mode for collecting the direction statistical value may takes place when the control system monitors whether a quantity of the manufacturing line changes, and the quantity is changed.

According to the exemplary embodiment of the present invention, the direction statistical value is collected for each time section, and when a usage difference for each direction exceeds a set value in each time section, the direction of the switching unit may be changed to a direction with more usage.

According to the exemplary embodiment of the present invention, the time section may be divided into a time section preset by a user.

According to the exemplary embodiment of the present invention, the time section may be divided centered on an inflection point at which usage for each direction changes based on the direction statistical value.

According to the exemplary embodiment of the present invention, the switching unit is provided in plural, a first switching unit among the switching units operates in a constant driving mode in which the direction is always switched based on whether the transfer unit enters a first switching zone, in which the first switching unit is provided, collected by the sensor, and a task allocated to the transfer unit, a second switching unit among the switching units operates in a fixed mode in which the direction is fixed for a certain period of time based on a statistical value for each direction of the second switching unit collected by the control system controlling the transfer unit, and a third switching unit among the switching units may operates in a pattern analysis mode in which the direction is changed for each time section based on a statistical value for each direction of the third switching unit collected by the control system.

An exemplary embodiment of the present disclosure, a program may stored in a recording medium executing the method of controlling the transfer system of claim 1.

An exemplary embodiment of the present disclosure, a transfer system, comprising: a rail provided on a ceiling of a semiconductor manufacturing line; a plurality of transfer units traveling along the rail; and a control system for controlling the plurality of transfer units, wherein the rail includes: a traveling rail that is in contact with a traveling wheel of the transfer unit; and a switching unit that is in contact with a steering wheel of the transfer unit and changes a lane of the transfer unit in both directions, and the control system collects traveling information obtained while the transfer unit travels along the rail installed on the semiconductor manufacturing line, and may controls a direction of the switching unit based on the collected traveling information.

According to the exemplary embodiment of the present invention, the transfer system may further include a sensor for collecting the traveling information about whether the transfer unit enters a switching zone where the switching unit is provided, wherein the control system allocates a task to the transfer unit, derives a traveling path of the transfer unit based on the allocated task and checks whether the switching unit exists on the derived traveling path, presets the direction of the switching unit according to the traveling path when the switching unit exists on the traveling path, checks whether the transfer unit enters the switching zone through the sensor, and changes the direction of the switching unit prior to a set time before the transfer unit enters the switching unit, and a switching time required for the switching unit to change the direction may be shorter than the set time.

According to the exemplary embodiment of the present invention, the control system collects the traveling information which is information on a direction statistical value representing usage for each direction of the switching unit when the transfer unit enters the switching unit, switches a mode of the switching unit to a constant driving mode when a quantity of the semiconductor manufacturing line changes, collects the direction statistical value while the switching unit is operating in the constant driving mode, and changes the direction of the switching unit based on the collected direction statistical value, and the changed direction of the switching unit may be maintained until the change in the quantity of the semiconductor manufacturing line is confirmed again.

According to the exemplary embodiment of the present invention, the control system collects the traveling information which is information on a direction statistical value representing usage for each direction of the switching unit when the transfer unit enters the switching unit, and the direction statistical value is collected for each time section, and when a usage difference for each direction exceeds a set value in each time section, the direction of the switching unit may be changed to a direction with more usage.

According to the exemplary embodiment of the present invention, it is possible to improve the efficiency of transferring the article in the manufacturing line.

According to the exemplary embodiment of the present invention, the traveling lane of the transfer unit may be changed in both directions.

According to the exemplary embodiment of the present invention, it is possible to improve the traveling efficiency of the transfer unit by setting a switching direction of the switching unit based on the traveling information of the transfer unit.

Effects of the present disclosure are not limited to those described above and effects not stated above will be clearly understood to those skilled in the art from the specification and the accompanying drawings.

### BRIEF DESCRIPTION OF THE DRAWINGS

FIG. 1 is a diagram schematically illustrating a manufacturing line viewed from above.

FIG. 2 is a diagram of a transfer unit travelling on a rail of FIG. 1 viewed from the front.

FIG. 3 is a diagram of the transfer unit traveling on the rail of FIG. 1, viewed from the side.

FIG. 4 is a diagram of the transfer unit traveling in a branching zone of FIG. 1 viewed from above.

FIG. 5 is a diagram illustrating a state in which the transfer unit of the present invention travels while maintaining a traveling direction in a branching zone, viewed from above.

FIG. 6 is a diagram illustrating a state in which the transfer unit of the present invention travels while changing a traveling direction in a branching zone viewed from above.

FIG. 7 is a diagram illustrating a switching unit provided in a switching zone of FIG. 1, viewed from above.

FIG. 8 is a diagram illustrating a state in which the transfer unit changes the traveling lane from a first lane to a second lane in the switching zone of FIG. 1.

FIG. 9 is a diagram illustrating a state in which the transfer unit maintains the traveling lane as the first lane in the switching zone of FIG. 1.

FIG. 10 is a diagram illustrating a state in which the transfer unit changes the traveling lane from the second lane to the first lane in the switching zone of FIG. 1.

FIG. 11 is a flowchart schematically illustrating a control method of the transfer system according to an exemplary embodiment of the present invention.

FIG. 12 is a flowchart illustrating a first exemplary embodiment of the control method of FIG. 11.

FIG. 13 is a flowchart illustrating a second exemplary embodiment of the control method of FIG. 11.

FIG. 14 is a flowchart illustrating a third exemplary embodiment of the control method of FIG. 11.

FIG. 15 is a flowchart illustrating a fourth exemplary embodiment of the control method of FIG. 11.

The various features and advantages of the non-limiting exemplary embodiment of the present specification may become more apparent by reviewing the detailed description together with the accompanying drawings. The accompanying drawings are provided for illustrative purposes only and should not be construed as limiting the scope of claims. The accompanying drawings are not considered to be drawn to scale unless explicitly stated. For clarity, the various dimensions of the drawings may have been exaggerated.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

When the term “same” or “identical” is used in the description of example embodiments, it should be understood that some imprecisions may exist. Thus, when one element or value is referred to as being the same as another element or value, it should be understood that the element or value is the same as the other element or value within a manufacturing or operational tolerance range (e.g., ±10%).

When the terms “about” or “substantially” are used in connection with a numerical value, it should be understood that the associated numerical value includes a manufacturing or operational tolerance (e.g., ±10%) around the stated numerical value. Moreover, when the words “generally” and “substantially” are used in connection with a geometric shape, it should be understood that the precision of the geometric shape is not required but that latitude for the shape is within the scope of the disclosure.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

A transfer system 1 of the present exemplary embodiment may be used to transfer a container 20. In particular, the transfer system 1 of the present exemplary embodiment may transfer the container 20 in which the article is stored. The article may be a substrate, such as a wafer, or a reticle. The container 20 in which the article is accommodated may be a Front Opening Unified Pod (FOUP) or a cassette. Also, the container 20 in which the article is accommodated may be a POD. Furthermore, the container 20 in which an article is accommodated may be a magazine for accommodating multiple printed circuit boards or a tray for accommodating multiple semiconductor packages.

In the following, the present invention will be described based on the case where the transfer system 1 transfers the container 20 in which a substrate, such as a wafer, is accommodated to the semiconductor manufacturing devices 10 arranged in the semiconductor manufacturing line as an example. The present invention will be described based on the case where the article transferred by the transfer system 1 is a wafer used for manufacturing a semiconductor device as an example. However, the present invention is not limited thereto, and the transfer system (1) of the present exemplary embodiment may be applied equally or similarly to various manufacturing lines that require the transfer of an article and/or the containers (20) in which articles are accommodated.

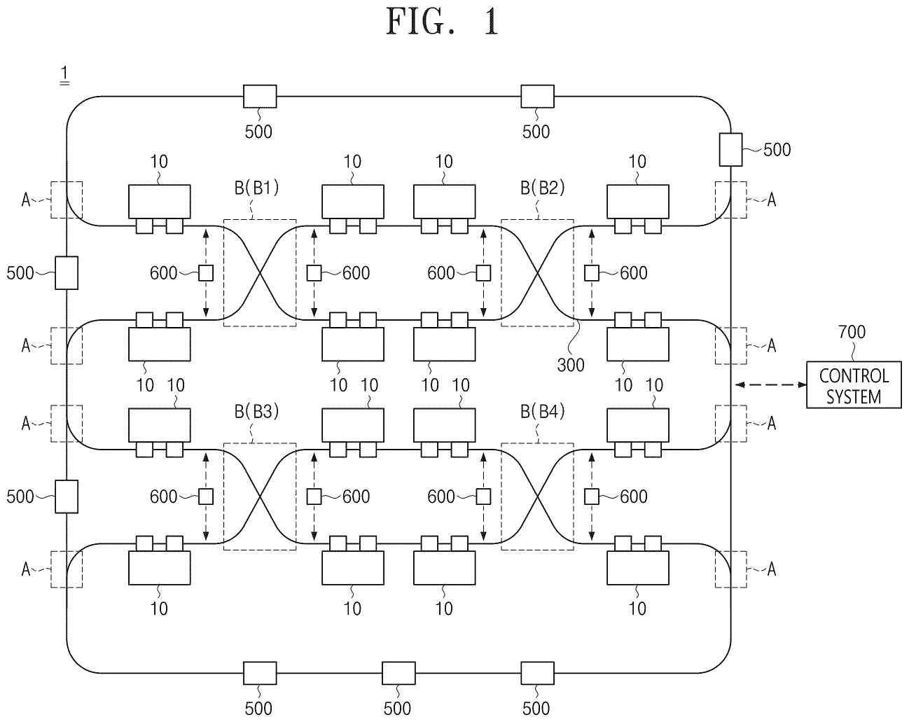

Hereinafter, an exemplary embodiment of the present invention will be described in detail with reference to FIGS. 1 to 15.

FIG. 1 is a diagram schematically illustrating a manufacturing line viewed from above.

Referring to FIG. 1, a plurality of substrate processing apparatuses 10 is provided in a manufacturing line, for example, a semiconductor manufacturing line for manufacturing a semiconductor device. The substrate processing apparatus 10 may be semiconductor manufacturing equipment that performs a process of manufacturing a semiconductor device. The substrate processing apparatus 10 may be configured to perform various types of processes required to manufacture semiconductor devices, such as a cleaning process, a photo process, an etch process, an ion implantation process, an ashing process, and a deposition process.

A plurality of substrate processing apparatuses 10 is disposed on the manufacturing line to be spaced apart from each other. Furthermore, a substrate processed by the substrate processing apparatus 10, such as a wafer requiring processing, may be loaded into and transferred to the substrate processing apparatus 10 while being accommodated in the above-described container 20, and the processed wafer may be unloaded and transferred from the substrate processing apparatus 10.

The transfer of the container 20 to or from the substrate processing apparatus 10 may be implemented by the transfer system 1 according to the exemplary embodiment of the present invention. The transfer system 1 may receive a task set by a user, and may transfer the container 20 between the plurality of substrate processing apparatuses 10 according to the allocated task. Processes implemented by the substrate processing apparatus 10 may be applied to the substrates, which are the articles transferred by the transfer system 1. Accordingly, a semiconductor device may be manufactured from a substrate, such as a wafer.

The transfer system 1 may be an Overhead Hoist Transfer (OHT) system. The transfer system 1 may include a rail 300, a transfer unit 500, a sensor 600, and a control system 700.

The rail 300 provides a path on which the transfer unit 500, which will be described later, travels. The rail 300 may include a traveling rail 310, a branch rail 330, and a switching unit 500. The rail 300 may be fixedly installed on the ceiling of the semiconductor manufacturing line. The transfer unit 500, which will be described later, may travel along the rail 300. The transfer unit 500 may be configured to transfer the container 20 on the substrate processing apparatus 10 while traveling along the rail 300 fixedly installed on the ceiling.

In addition to a general traveling zone, a plurality of branching zones A and a plurality of switching zones B may be included in the traveling path in which the transfer unit 500 travels along the rail 300. The branching zone A and the switching zone B may be zones in which the lane of the transfer unit 500 is changed. Also, the branching zone A may be a zone in which the lane of the transfer unit 500 is changed in only one direction. For example, the branching zone A may be a zone in which the lane of the transfer unit 500 may be changed from the first lane to the second lane, but cannot be changed from the second lane to the first lane. Also, the switching zone B may be a zone in which the lane of the transfer unit 500 is changed in both directions. For example, in the switching zone B, the lane of the transfer unit 500 may be changed from the first lane to the second lane, and in addition, may also be changed from the second lane to the first lane.

While traveling along the rail 300, the transfer unit 500 may load and transfer the container 20 to the substrate processing apparatus 10 located below the rail 300, or unload and transfer the container 20 placed on the substrate processing apparatus 10.

The sensor 600 is a configuration capable of detecting the transfer unit 500 entering or exiting the switching zone B. The sensor plays an essential role in ensuring smooth operation of the transfer system 1 and monitoring the exact location and state of the transfer unit 500.

There are various types of sensors 600, and each sensor may be used appropriately for a specific use and environment. Various known sensors, such as an optical sensor, a magnetic sensor, an ultrasonic sensor, an RFID sensor, a vision sensor, and a pressure sensor, may be applied to the sensor 600.

An optical sensor is a sensor that detects an object using light. A laser, an infrared ray, an LED, or the like may be used to determine the position of the transfer unit 500. The sensor includes a reflective sensor, a transmissive sensor, and a laser range finder. For example, when the transfer unit 500 enters the switching zone B, an optical sensor may detect the entrance of the transfer unit 500 and send a signal to the control system 700.

A magnetic sensor is a sensor that detects an object using a magnetic field. A magnet may be attached to the transfer unit 500 or a device for generating a magnetic field may be installed in the switching zone B to detect an object. There are Hall effect sensors, magnetic resistance sensors, and the like. When the transfer unit 500 approaches the switching zone B, the magnetic sensor may detect the approach of the transfer unit 500 and transmit a signal.

An ultrasonic sensor is a sensor that emits ultrasonic waves and receives reflected waves to recognize a location of an object. The ultrasonic sensor is capable of measuring a distance and is useful for detecting the presence or absence of objects. An ultrasonic sensor may be installed in the switching zone B to detect the entry and exit of the transfer unit 500.

A Radio Frequency Identification Sensor (RFID) is a sensor that recognizes an object to which a tag is attached using radio frequencies. An RFID tag may be attached to the transfer unit 500 and an RFID reader may be installed in the switching zone B to detect the RFID tag. When the transfer unit 500 enters or exits the switching zone B, the RFID reader may recognize the entry or exit of the transfer unit 500 and collect data.

A vision sensor is a sensor that detects an object using a camera and image processing technology. The location, shape, and size of an object may be recognized through high-resolution images. A vision sensor is installed in the switching zone B to monitor the movement of the transfer unit 500 in real time, and the control system 700 may perform appropriate control based on the monitored movement.

A pressure sensor is a sensor that detects the weight or pressure of an object. When the transfer unit 500 reaches a specific position, it may be detected by a change in pressure. A pressure sensor may be installed in the switching zone B to confirm the presence of the transfer unit 500.

When the transfer unit 500 enters the switching zone B or the transfer unit 500 exits the switching zone B, the sensor 600 may transmit information about the entry or exist of the transfer unit 500 to the control system 700. Accordingly, the control system 700 may monitor the position and state of the transfer unit 500 in real time, and increase the efficiency and stability of the transfer system 1.

The control system 700 may control the transfer system 1. The control system 700 is a core system for controlling the transfer system 1, and may allocate tasks to a plurality of transfer units 500 and collect information on the transfer units 500. The control system 700 plays an important role for efficient operation of the transfer system.

The control system 700 may collect the locations of the transfer units 500, the moving speed, the moving acceleration, the traveling path of the transfer units 500, information on the container 20 transferred by the transfer unit 500, information on the article accommodated in the container 20, and the like. Such information is essential for real-time recognition and optimization of the operational status of the transfer system.

The control system 700 may exchange a control signal and traveling information with the controller 590 of each transfer unit 500. The control signal and the traveling information may be exchanged by a wired or wireless communication method, and various communication methods may be used. For example, wired communication methods include Ethernet and Controller Area Network (CAN), and wireless communication methods include Wi-Fi, ZigBee, Bluetooth, Radio Frequency Identification (RFID), and 5G technologies. Through these various communication methods, reliable and rapid data exchange between the control system 700 and the transfer unit 500 is possible.

The control system 700 may be configured to include a recording medium, a processor, hardware, software, an input device, an output device, a communication device, and the like. As the recording medium, various recording media may be used to store and manage data. The recording medium may include a Hard Disk Drive (HDD), a Solid State Drive (SSD), a USB flash drive, an SD card, and the like. The recording medium stores operating data of the system for a long time and allows quick access if necessary. A program capable of implementing a control method of a transfer system to be described later may be stored in the recording medium.

The processor may perform complex arithmetic operations including a high performance processor. The processor may be a Central Processing Unit (CPU), a Graphics Processing Unit (GPU), a Field-Programmable Gate Array (FPGA), or the like, and effectively manages real-time data processing and control signals. The processor may execute a program that may implement a control method of the transfer system to be described below.

Hardware includes various hardware components. The hardware may consist of a main board, a power supply device, a network interface card, a sensor interface module, and the like. The hardware components serve to ensure the reliability and performance of the system.

As software, such as a program, various software programs are operated. The software may include an Operating System (OS), a control application, a Database Management System (DBMS), a communication protocol stack, and the like. The software serves to process traveling information of the transfer units 500 and generate an optimal control command.

As an input device, an operator may control the system and input data through various input devices, such as a keyboard, a mouse, and a touch screen. As an output device, information may be output through various output devices, such as displays and warning lights. The display device helps to visually check the state of the system.

The control system 700 efficiently operates the transfer system 1 through these various components and ensures smooth traveling of the transfer units 500.

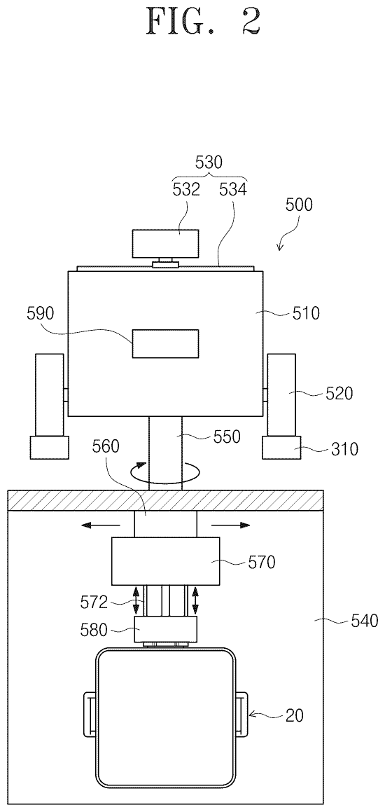

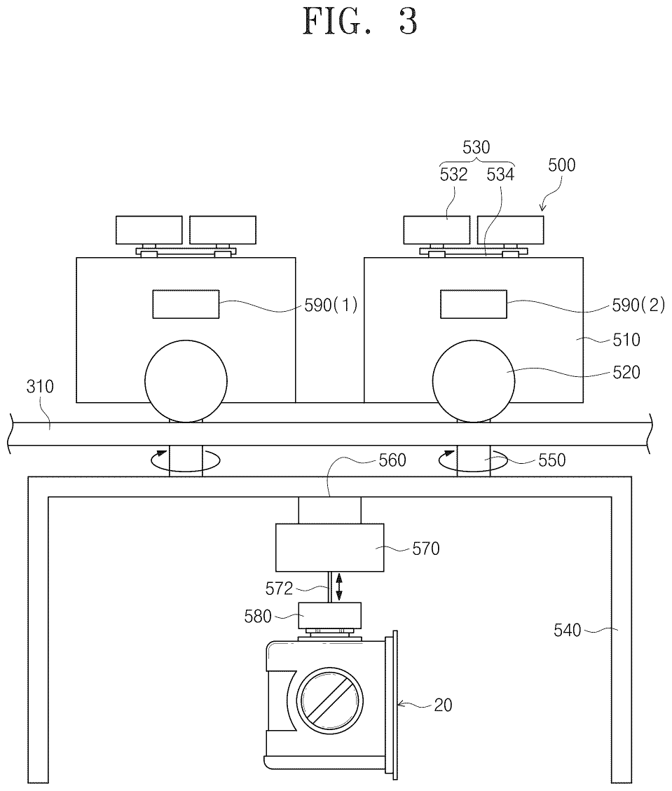

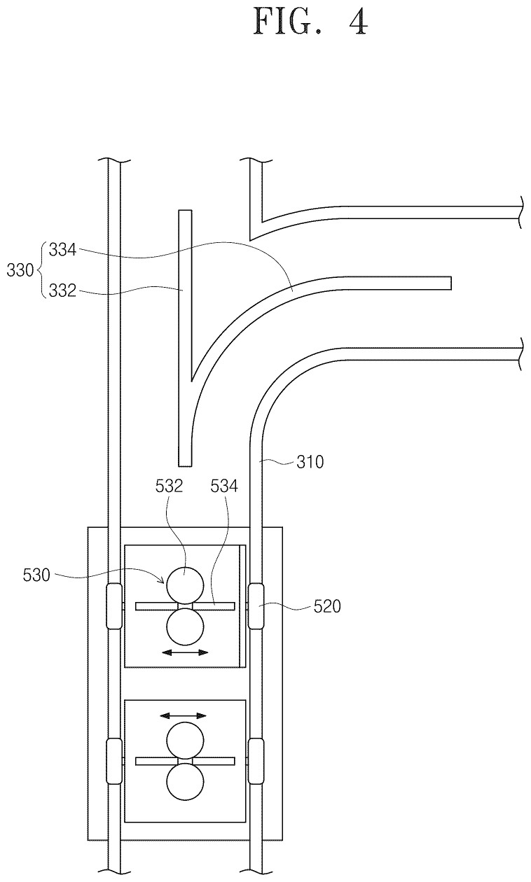

FIG. 2 is a diagram of the transfer unit 500 travelling on the rail 300 of FIG. 1 viewed from the front, FIG. 3 is a diagram of the transfer unit 500 traveling on the rail 300 of FIG. 1, viewed from the side, and FIG. 4 is a diagram of the transfer unit 500 traveling in the branching zone A of FIG. 1 viewed from above.

As described above, the transfer system 1 may include a rail 300 and a transfer unit 500.

The rail 300 may include a traveling rail 310, a steering rail 330, and a switching unit 500.

The traveling rail 310 may provide a traveling path on which the transfer unit 500 to be described below travels. The traveling wheel 520 of the transfer unit 500 to be described below may be in contact with the traveling rail 310. A plurality of traveling rails 310 may be provided while being spaced apart from each other. For example, the traveling rails 310 may be provided in a pair. The pair of traveling rails 310 may be parallel to each other and may be provided at the same height.

The steering rail 330 may change the traveling direction of the transfer unit 500 to be described below. The steering rail 330 may change the traveling direction of the transfer unit 500 to change the lane in which the transfer unit 500 travels. The steering rail 330 may be in contact with the steering wheel 532 of the transfer unit 500 to be described below. The steering rail 330 may include a straight branch rail 332 and a curved branch rail 334. The straight branch rail 332 may maintain the traveling path of the transfer unit 500 in the zone where the traveling rail 310 branches. That is, the transfer unit 500 traveling along the straight branch rail 332 may maintain the existing lane as it is. Also, the curved branch rail 334 may change the traveling path of the transfer unit 500 in the zone where the traveling rail 310 branches. That is, the lane of the transfer unit 500 traveling along the curved branch rail 334 may be changed.

The transfer unit 500 may travel on the rail 300. The transfer unit 500 may travel on the traveling rail 310. The transfer unit 500 may grip the container 20. The transfer unit 500 may travel on the rail 300 while gripping the container 20. The transfer unit 500 may include a body 510, a traveling wheel 520, a steering member 530, a frame 540, a neck 550, a slider 560, a lifting member 570, a grip member 580, and a controller 590.

The traveling wheel 520, the steering member 530, and the neck 550 may be coupled to the body 510. The traveling wheel 520 may be rotatably coupled to the body 510. Also, the steering member 530 may be provided on an upper surface of the body 510. Also, the neck 550 may be rotatably coupled to the body 510.

The body 510 may have a travelling driver (not illustrated) therein. The driver may rotate the traveling wheel 520. The traveling driver may be a motor. The traveling driver may transmit power to the traveling wheel 520 to rotate the traveling wheel 520. Also, a plurality of bodies 510 may be provided. Each body 510 may have the traveling driver described above. Also, the traveling wheel 520, the steering member 530, and the neck 550 may be coupled to each body 510.

The traveling wheel 520 may be rotatably coupled to the body 510. The traveling wheel 520 may be in contact with the rail 300 and rotated. The traveling wheel 520 may be rotatably coupled to the body 510. The traveling wheel 520 may be rotatably coupled to the body 510. The traveling wheel 520 may be in contact with the traveling rail 310 in the rail 300 and rotate to travel on the traveling rail 310. A plurality of traveling wheels 520 may be provided. A pair of traveling wheels 520 may be provided. One of the traveling wheels 520 may be rotatably coupled to one surface of the body 510, and the other of the traveling wheels 520 may be rotatably coupled to the other surface opposite to one surface of the body 510.

The steering member 530 may be provided on an upper portion of the body 510. The steering member 530 may include a plurality of steering wheels 532 and a steering rail 534. When viewed from above, the steering wheel 532 may be disposed along a direction parallel to the traveling direction of the transfer unit 500. Also, when viewed from above, the longitudinal direction of the steering rail 534 may be parallel to a direction perpendicular to the traveling direction of the transfer unit 500. Also, the position of the steering wheel 532 may be changed along the longitudinal direction of the steering rail 534.

The frame 540 may have an inner space. The slider 560, the lifting member 570, and the grip member 580, which will be described later, may be provided in the inner space of the frame 540. Also, the frame 540 may have a hexahedral shape with opposite side surfaces and a lower surface open. That is, the front surface and the rear surface of the frame 540 may be provided as a blocking plate. Thus, when the transfer unit 500 travels, the gripped container 20 may be prevented from being shaken due to air resistance. Also, the frame 540 may be coupled to the body 510 via the neck 550. The neck 550 may be provided to be rotatable with respect to the body 510 and the frame 540. The frame 540 may be coupled to at least one body 510 via at least one neck 550. For example, the frame 540 may be provided as one, and two necks 550 may be coupled to one frame 540. In addition, the two necks 550 may be coupled to different bodies 510, respectively.

The slider 560 may be coupled to the frame 540. The slider 560 may be coupled to the frame 540 so that its position may be changed with respect to the frame 540. The slider 560 may be provided in the inner space of the frame 540 and may be coupled to a lower surface of the frame 540. The slider 560 may be coupled to the frame 540 so that its position may be changed laterally to the left or right with respect to the traveling direction of the transfer unit 500. Furthermore, the slider 560 may be coupled to the lifting member 570 to be described later. Accordingly, the position of the lifting member 570 may be changed by changing the position of the slider 560.

The lifting member 570 may elevate and lower the grip member 580. The lifting member 570 may be coupled to the body 510 via the frame 540 and/or the neck 550. The lifting member 570 may include a driver (not illustrated) therein. The driver may elevate or lower the grip member 580 by winding or unwinding a belt 572 connected to the grip member 580. The lifting member 570 may be referred to as a hoist unit.

The grip member 580 may grip the container 20. The grip member 580 may detachably grip the container 20. The grip member 580 may load the container 20 to a load port of the semiconductor processing apparatus or may unload the container 20 from the load port. The grip member 580 may be referred to as a grip unit.

The controller 590 may exchange a signal and traveling information with the control system 700, and may generate a control signal capable of controlling the operation of the transfer unit 500. The controller 590 may be composed of a processor, a recording medium, a substrate, a circuit element, and the like. The processor is a core component of the controller, and controls and manages the operation of the transfer unit 500 in real time. As the processor, a high performance Central Processing Unit (CPU), Graphics Processing Unit (GPU), Digital Signal Processor (DSP), Field-Programmable Gate Array (FPGA), and the like may be used. The processor may quickly process a complicated control task by providing high-speed computation capability.

The recording medium serves to store and manage data required by the controller 590. As the recording medium, a Static Random Access Memory (SRAM), a Dynamic Random Access Memory (DRAM), a flash memory, a Solid State Drive (SSD), and the like may be used. The recording medium stores program codes, traveling information, setting values, and the like, and allows quick access when needed. The substrate serves to physically support and electrically connect all electronic components of the controller 590. A substrate is generally made of a Printed Circuit Board (PCB), and various circuit elements are attached thereto. The PCB uses high-density wiring technology to minimize signal interference while using space efficiently.

The circuit element is composed of electronic components necessary to realize various functions of the controller. The circuit element may include a resistor, a capacitor, an inductor, a diode, an Integrated Circuit (IC), and the like. These elements perform various functions, such as power management, signal processing, and data communication.

A plurality of controllers 590 may be provided, and may be provided to the bodies 510, respectively. Among them, a first controller 590(1) is provided to a master controller, and a second controller 590(2) is provided to a slave controller. The operation of the transfer unit 500 is led by the first controller 590(1) and controlled by the second controller 590(2) in a manner that the second controller 590(2) follows the control of the first controller 590(1).

The master controller 590(1) controls the operation of the entire transfer unit as a whole and generates main control signals, such as a transfer path, speed, and acceleration. Furthermore, the master controller directly communicates with the control system 700 to collect traveling information and receives control signals. The master controller mainly has a stronger processor and a memory of larger capacity to perform complex control tasks. The slave controller 590(2) receives the control signal from the master controller 590(1) and controls detailed operations of the transfer unit 500 based on the received control signal. The slave controller performs a command of the master controller, and thus precise control of the transfer unit 500 is possible. Since the slave controller plays an auxiliary role, the slave controller may have a relatively simple structure.

Through cooperative control between the controllers 590, the transfer unit 500 may operate stably and efficiently, thereby improving the overall performance of the transfer system 1.

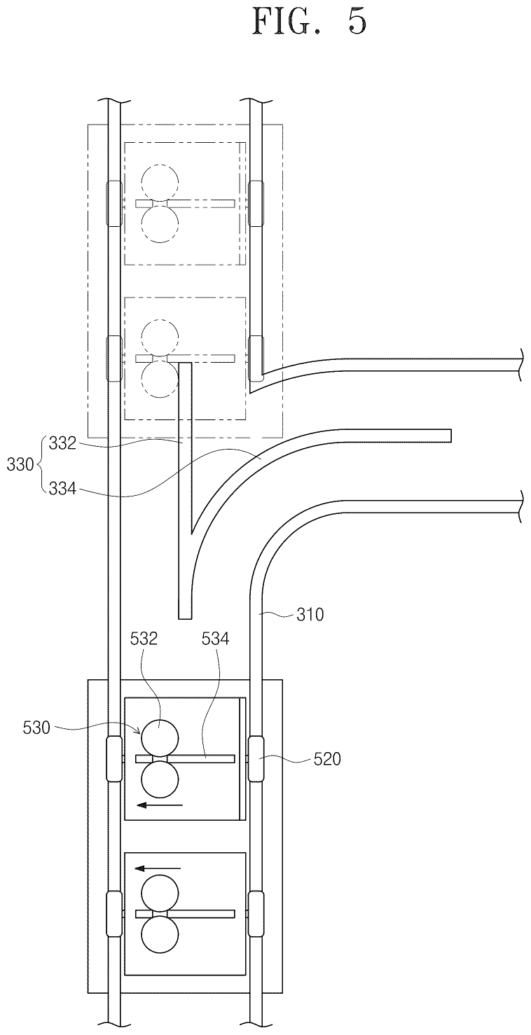

FIG. 5 is a diagram illustrating a state in which the transfer unit 500 of the present invention travels while maintaining the traveling direction in the branching zone A, viewed from above.

Referring to FIG. 5, when the transfer unit 500 travels while maintaining the traveling direction in the branching zone, the steering wheel 532 of the steering member 530 is moved to a position where the steering wheel 532 is in contact with the straight branch rail 332. Accordingly, the traveling wheel 520 is in contact with any one of the traveling rails 310 in the branching zone, the steering wheel 532 is in contact with the straight branch rail 332, and the traveling direction of the transfer unit 500 is maintained.

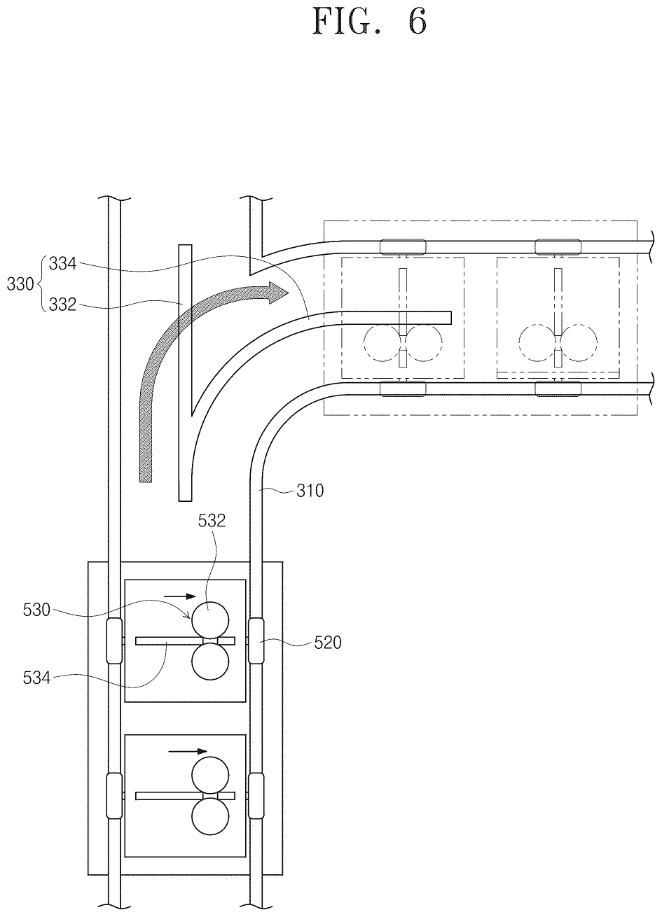

FIG. 6 is a diagram illustrating a state in which the transfer unit 500 of the present invention travels while changing the traveling direction in the branching zone A, viewed from above.

Referring to FIG. 6, when the transfer unit 500 changes the traveling direction in the branching zone, the steering wheel 532 of the steering member 530 is moved to a position where the steering wheel 532 is in contact with the curved branch rail 334. Accordingly, the traveling wheel 520 is in contact with any one of the traveling rails 310 in the branching zone, the steering wheel 532 is in contact with the curved branch rail 334, and the traveling direction of the transfer unit 500 is changed.

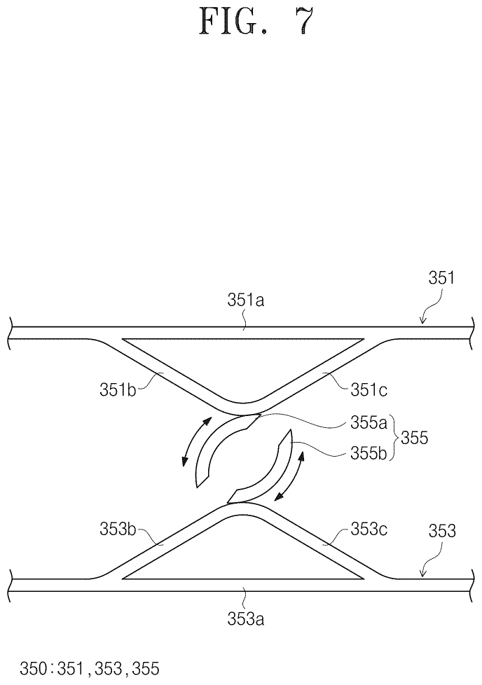

FIG. 7 is a diagram illustrating the switching unit provided in the switching zone B of FIG. 1, viewed from above.

The switching unit 350 may be provided in the switching zone B according to the exemplary embodiment of the present invention. The switching unit 350 may change a lane of the transfer unit 500. For example, the switching unit 350 may switch a lane of the transfer unit 500 traveling along the traveling rail 310 from the first lane to the second lane, or from the second lane to the first lane.

The switching unit 350 may include a first switching rail 351, a second switching rail 353, and a switching mechanism 355. The traveling rail 310 corresponding to the first lane may be disposed under the first switching rail 351. Also, the traveling rail 310 corresponding to the second lane may be disposed under the second switching rail 353. The first switching rail 351 and the second switching rail 353 may be disposed to face each other. The first switching rail 351 and the second switching rail 353 may have shapes symmetrical to each other with respect to the switching mechanism 355.

The first switching rail 351 may include a first straight traveling portion 351a, a first entry guide portion 351b, and a first exit guide portion 351c. The first straight traveling portion 351a may have an inner surface and an outer surface. Here, the inner surface may be a surface facing the switching mechanism 355, and the outer surface may be a surface opposite to the inner surface. The first straight traveling portion 351a may extend in a direction parallel to the traveling rail 310, which may correspond to the first lane located below the first switching rail 351. The first entry guide portion 351b may extend obliquely in a direction from the first straight traveling portion 351a to be closer to the switching mechanism 355. The first exit guide portion 351c may extend obliquely in a direction closer to the first entry traveling portion 351a from the first entry guide portion 351b.

When viewed from above, a space between the first straight traveling portion 351a, the first entry guide portion 351b, and the first exit guide portion 351c may generally have a triangular shape. Inner surfaces of the first entry guide portion 351b and the first exit guide portion 351c may be continuous with the inner surface of the first straight traveling portion 351a.

The second switching rail 353 may also include a second straight traveling portion 353a, a second entry guide portion 353b, and a second exit guide portion 353c. The second straight traveling portion 353a may have an inner surface and an outer surface. Here, the inner surface may be a surface facing the switching mechanism 355, and the outer surface may be a surface opposite to the inner surface. The second straight traveling portion 353a may extend in a direction parallel to the traveling rail 310, which may correspond to the second lane located below the second switching rail 353. The second entry guide portion 353b may extend obliquely in a direction from the second straight traveling portion 351a to be closer to the switching mechanism 355. The second exit guide portion 353c may extend obliquely in a direction closer to the second straight traveling portion 353a from the second entry guide portion 353b. When viewed from above, a space between the second straight traveling portion 353a, the second entry guide portion 353b, and the second exit guide portion 353c may generally have a triangular shape. Inner surfaces of the second entry guide portion 353b and the second exit guide portion 353c may be continuous with the inner surface of the second straight traveling portion 353a.

The switching mechanism 355 allows the lane of the transfer unit 500 entering the switching unit 350 to be switched in both directions. The switching mechanism 355 may be disposed between the first switching rail 351 and the second switching rail 353. Specifically, the switching mechanism 355 may be disposed in a space between a point where the first entry guide portion 351b and the first exit guide portion 351c of the first switching rail 351 meet, and a point where the second entry guide portion 353b and the second exit guide portion 353c of the second switching rail 353 meet. The switching mechanism 355 may be configured to be rotated in a clockwise or counterclockwise direction by an actuator, such as a motor or a pneumatic/hydraulic cylinder, of the switching unit 350. The switching mechanism 355 may be driven by wirelessly receiving power from a power cable that may be installed on the rail 300.

The switching mechanism 355 may include a first switching member 355a and a second switching member 355b. The first switching member 355a and the second switching member 355b may generally have an elliptical arc shape, and may have shapes that are symmetrical to each other. The first switching member 355a and the second switching member 355b face each other, and may be disposed to be spaced apart from each other. A space between the first switching member 355a and the second switching member 355b may be provided as a space through which the steering wheel 532 of the transfer unit 500 may pass. Inner surfaces of the first switching member 355a and the second switching member 355b may be surfaces that are in contact with the steering wheel 532 of the transfer unit 500.

The switching mechanism 355 may rotate in a direction selected from the first direction and the second direction. The lane of the transfer unit 500 entering the switching unit 350 may be changed by the rotation of the switching mechanism 355.

In addition, the traveling rail 310, which the traveling wheel 520 of the transfer unit 500 contacts, may be provided under the switching mechanism 355. Specifically, the traveling rail 310, which the traveling wheel 520 of the transfer unit 500 contacts while the transfer unit 500 changes a lane, may be provided under the first and second entry guide portions 351b and 353b, the first and second exit guide portions 351c and 353c, and the switching mechanism 355. The traveling rail 310 located under the first and second entry guide portions 351b and 353b, the first and second exit guide portions 351c and 353c, and the switching mechanism 355 may be referred to as a switching traveling rail.

Furthermore, the switching unit 350 may include a control device capable of receiving a control signal from the above-described control system 700. The control device of the switching unit 350 may include a communication means, such as a LAN card, and may be configured to receive a control signal from the control system 700 and generate a current signal for controlling an actuator of the switching unit 350 based on the received control signal. That is, the direction of the switching unit 350 (more specifically, the direction of the switching mechanism 355) may be changed based on the control signal transmitted from the control system 700.

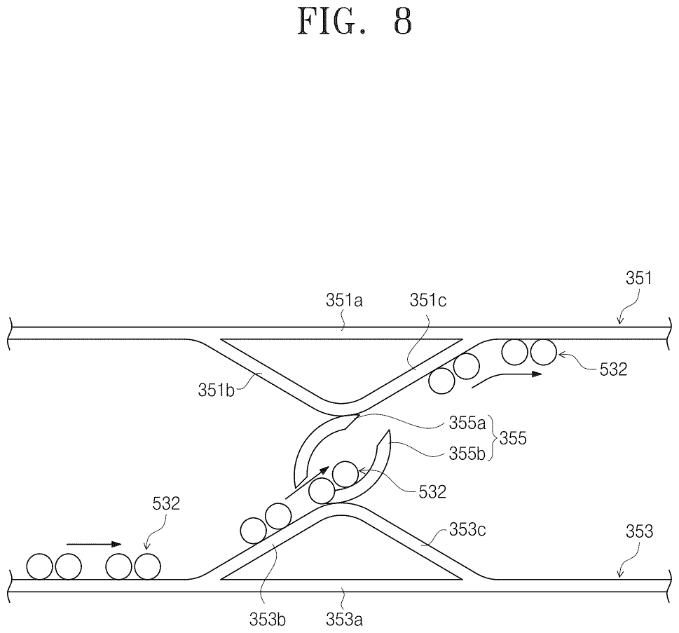

FIG. 8 is a diagram illustrating a state in which the transfer unit 500 changes the traveling lane from the first lane to the second lane in the switching zone B of FIG. 1.

Referring to FIG. 8, when the transfer unit 500 travels on the second lane, which is the traveling rail 310 located under the second switching rail 353, and then intends to change the lane to the first lane located under the first switching rail 351, the transfer unit 500 entering the switching zone B may enter the switching unit 350. In this case, the direction of the switching mechanism 355 may be set in the first direction.

Specifically, the steering wheel 532 may be moved to a position facing the inner surfaces of the second straight traveling portion 353a and the second entry guide portion 353b. In addition, the lane of the transfer unit 500 may be changed while the steering wheel 532 sequentially contacts the inner surface of the second entry guide portion 353b, the switching mechanism 355, and the inner surface of the first exit guide portion 351c.

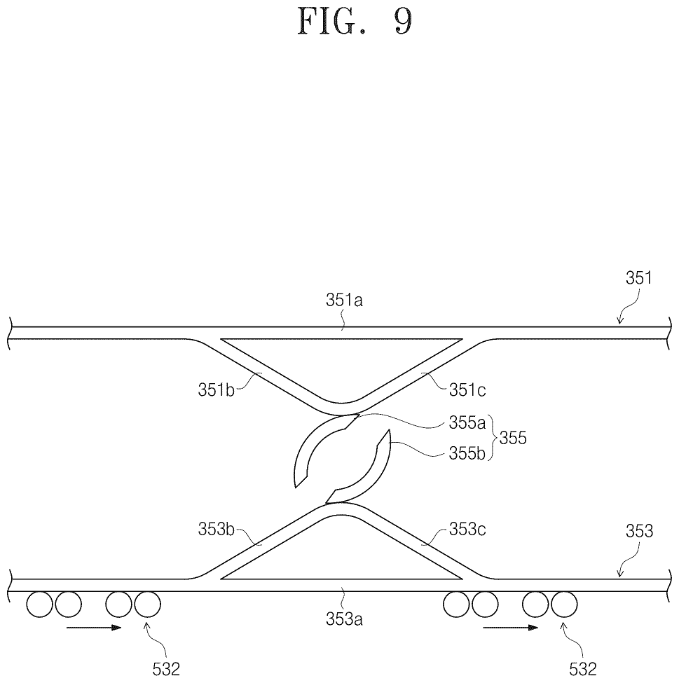

FIG. 9 is a diagram illustrating a state in which the transfer unit 500 maintains the traveling lane as the first lane in the switching zone B of FIG. 1.

Referring to FIG. 9, when the transfer unit 500 travels on the second lane, which is the traveling rail 310 located under the second switching rail 353, and then intends to maintain the lane in the second lane, the transfer unit 500 entering the switching zone B may pass through the switching unit 350.

The steering wheel 532 may be moved to a position facing the outer side surface of the second straight traveling portion 353a. Further, the lane of the transfer unit 500 may be maintained as it is while the steering wheel 532 moves in contact with the outer side surface of the second straight traveling portion 353a.

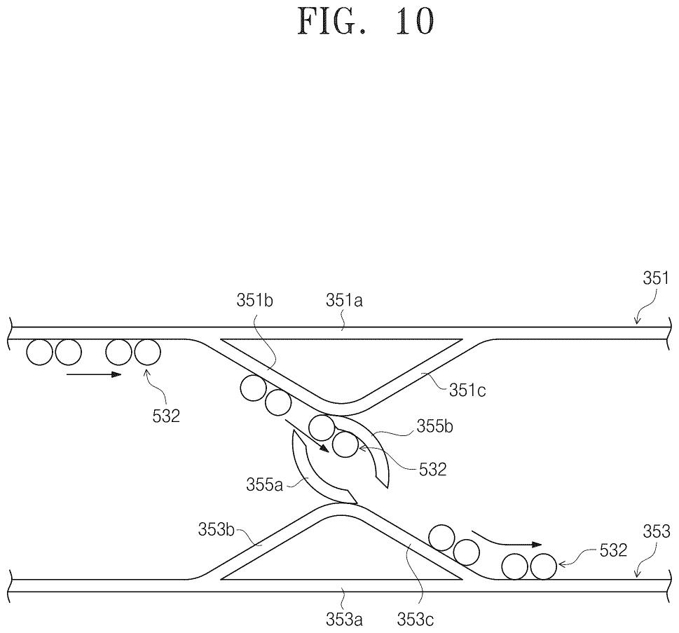

FIG. 10 is a diagram illustrating a state in which the transfer unit 500 changes the traveling lane from the second lane to the first lane in the switching zone B of FIG. 1.

Referring to FIG. 10, when the transfer unit 500 travels on the first lane, which is the traveling rail 310 located under the first switching rail 351, and then intends to change the lane to the second lane located under the second switching rail 353, the transfer unit 500 entering the switching zone B may enter the switching unit 350. In this case, the direction of the switching mechanism 355 may be set in the second direction.

Specifically, the steering wheel 532 may be moved to a position facing the inner surfaces of the first straight traveling portion 351a and the first entry guide portion 351b. In addition, the lane of the transfer unit 500 may be changed while the steering wheel 532 sequentially contacts the inner surface of the first entry guide portion 351b, the switching mechanism 355, and the inner surface of the second exit guide portion 353c.

In the above description, the first and second entry guide portions 351b and 353b and the first and second exit guide portions 351c and 353c may vary depending on the traveling direction of the transfer unit 500. As illustrated in FIGS. 8 to 10, when the transfer unit 500 travels from the left to the right, 351b and 353b may be the entry guide portions, and 351c and 353c may be the exit guide portions, but when the transfer unit 500 travels from the right to the left, 351b and 353b may be the exit guide portions, and 351c and 353c may be the entry guide portions.

The above-described switching unit 350 may be provided in each of the switching zones B illustrated in FIG. 1. For example, the switching zone B may include first to fourth switching zones B1 to B4. In addition, the switching unit 350 may be provided in each of the first to fourth switching zones B1 to B4.

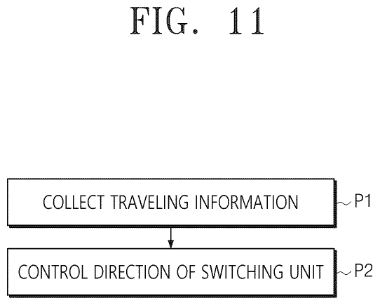

FIG. 11 is a flowchart schematically illustrating a control method of the transfer system 1 according to an exemplary embodiment of the present invention.

A control method of the transfer system 1 according to an exemplary embodiment of the present invention may be implemented by the switching unit 350, the transfer unit 500, and the control system 700 described above. The control method of the transfer system 1 according to the exemplary embodiment of the present invention may include a traveling information collection operation P1 and a switching unit direction control operation P2.

The switching unit direction control operation P2 may control the direction of the switching unit 350 based on the traveling information collected in the traveling information collection operation P1. Controlling the direction of the switching unit 350 may include setting the direction of the switching unit 350 according to the traveling path of the transfer unit 350 and changing the direction of the switching unit 350 according to the set direction. The traveling information may be traveling information obtained while the transfer unit 500 travels along the rail 300 as described above.

The traveling information of the transfer unit 500 may be, for example, information on whether the transfer unit 500 enters the switching zone B or whether the transfer unit 500 exits the switching zone B detected by the sensor 600. In addition, the traveling information of the transfer unit 500 may be information on whether the transfer unit 500 enters and exits the switching unit 350 set in the first direction, or enters and exits the switching unit 350 set in the second direction when the transfer unit 500 enters the switching zone B.

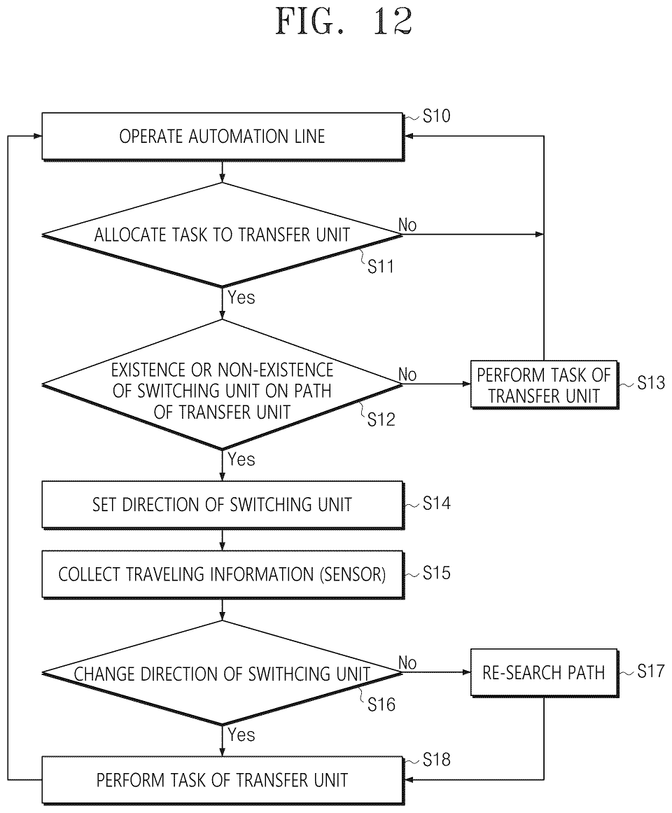

FIG. 12 is a flowchart illustrating a first exemplary embodiment of the control method of FIG. 11. In the first exemplary embodiment of the present invention, a case where the switching unit 350 is operated in [a constant driving mode] will be described as an example.

Referring to FIGS. 1, 7, and 12, in operation S10, the automation line is operated. The operation of the automation line may be performed by transferring the container 20 between the substrate processing apparatuses 10 according to the task allocated to the transfer units 500.

In operation S11, the control system 700 may allocate a new task to the transfer unit 500. Allocating the task may refer to the control system 700 allocating a command to the transfer unit 500 indicating which container 20 is to be transferred and where the container 20 is to be transferred. For example, allocating a task may refer to transferring the container 20 by the transfer unit 500 from one of the substrate processing apparatuses 10 to another substrate processing apparatus 10. As another example, allocating a task may refer to transferring the container 20 to any one of the substrate processing apparatuses 10 from a stocker (not illustrated), a container storage device that may be provided to a semiconductor manufacturing line. As another example, allocating a task may refer to transferring the container 20 to any one of the substrate processing apparatuses 10 from a side track buffer (not illustrated), a container storage device installed on the ceiling of a semiconductor manufacturing line.

In operation S11, when task allocation to the transfer unit 500 is not performed, the automation line of operation S10 is operated in the same manner as before. In operation S11, when work allocation to the transfer unit 500 is performed, operation S12 may be performed.

In operation S12, a traveling path of the transfer unit 500 for which task has been allocated may be derived. The task allocation may include a task of moving the transfer unit 500 to collect the container 20, a task of moving the transfer unit 500 to discharge the collected container 20, and the like. In operation S12, a traveling path with the shortest traveling path length and/or the shortest traveling time may be selected from among the number of cases of various traveling paths on which the transfer unit 500 may travel to perform the foregoing tasks.

In addition, it is possible to check whether the switching unit 350 exists on the selected traveling path.

In operation S12, when the switching unit 350 does not exist on the selected traveling path, operation S13 is performed so that the transfer unit 500 performs the task, and the automated operation line of operation S10 is operated while the new task of the transfer unit 500 is reflected.

In operation S12, when the switching unit 350 exists on the selected traveling path, operation S14 is performed, and the control system 700 sets the direction of the switching unit 350 according to the selected traveling path. For example, the direction of the switching unit 350 may be preset to the first direction or the second direction. However, in this case, the direction of the switching unit 350 may not be immediately changed. For example, the transfer unit 500 allocated with the task does not immediately enter the switching unit 350, because another transfer unit 500 may enter the switching unit 350. In other words, when the direction of the switching unit 350 is set and the direction of the switching unit 350 is directly changed based on the set direction, other transfer units 500 may interfere with the use of the switching unit 350.

Accordingly, operation S15 is performed. In operation S15, traveling information is collected. The traveling information may be traveling information collected by the sensor 600. For example, the traveling information may be information on whether the transfer unit 500 enters the switching zone B before the transfer unit 500 enters the switching zone B. The sensor 600 may sense whether the transfer unit 500 enters the switching zone B immediately before the transfer unit 500 enters the switching zone B. Alternatively, the sensor 600 may sense in advance whether the transfer unit 500 enters the switching zone B.

Thereafter, in operation S16, the direction of the switching unit 350 may be changed in accordance with the selected traveling path. For example, the direction of the switching unit 350 may be changed to the first direction or the second direction according to the traveling path. The direction of the switching unit 350 may be changed after the sensor 600 detects the transfer unit 500 and prior to a set time before the transfer unit 500 enters the switching unit 350. In this case, the switching time required for the switching unit 350 to change the direction may be shorter than the set time. A time difference between the switching time and the set time may be within several tens of seconds. For example, a time difference between the switching time and the set time may be within one minute. That is, in the present invention, traveling information (whether the transfer unit 500 enters the switching zone B) is collected through the sensor 600, and the direction of the switching unit 350 is changed immediately before the transfer unit 500 enters the switching unit 350, thereby minimizing the influence on other transfer units 500 when the transfer units 500 pass through the switching unit 350.

In operation S16, when the direction of the switching unit 350 is changed, operation S18 is performed to perform the task of the transfer unit 500. And, the automation line of operation S10 is operated while the new task is reflected.

In operation S16, when the direction of the switching unit 350 is not changed (e.g., a failure of the switching unit 350, or another transfer unit 500 enters the switching unit 350 first except when the transfer unit 500 changes the lane in the same direction), in operation S17, a new traveling path through which the allocated task can be completed may be re-searched. When the traveling path is re-searched, operation S18 is performed to perform the task of the transfer unit 500. And, the automation line of operation S10 is operated while the new task is reflected.

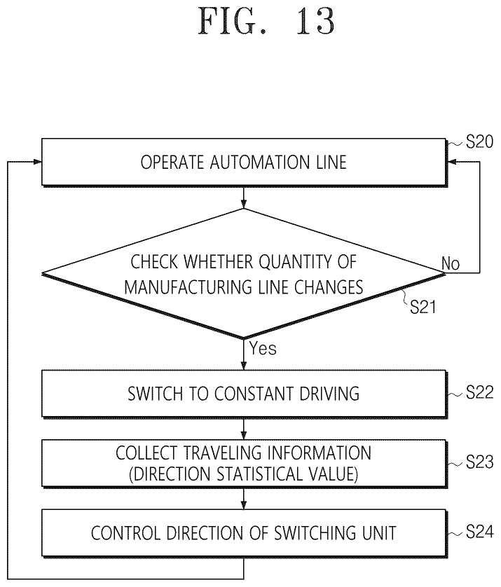

FIG. 13 is a flowchart illustrating a second exemplary embodiment of the control method of FIG. 11.

Referring to FIGS. 1, 7, and 13, in the second exemplary embodiment of the present invention, a case where the switching unit 350 is operated in a [fixed mode] will be described as an example.

Referring to FIGS. 1, 7, and 13, in operation S20, the automation line is operated. The operation of the automation line may be performed by transferring the container 20 between the substrate processing apparatuses 10 according to the task assigned to the transfer units 500. The difference between operation S20 and operation S10 described above is that in operation S20, the direction of the switching unit 350 is fixed in a preset direction. Accordingly, even when the transfer unit 500 is assigned a task and the switching unit 350 is included on the traveling path for performing the task, the control system 700 may derive a traveling path by treating the switching unit 350 substantially the same as the branch rail 330.

In operation S21, it is possible to check whether the quantity of the manufacturing line is changed. The check of whether the quantity is changed may be performed through the control system 700. The time interval for checking whether the quantity is changed may be preset by the user to a preset cycle of approximately 3 to 7 days. When the cycle preset by the user is reached, the control system 700 checks whether the quantity is changed through the control system 700. When the quantity is not changed on the manufacturing line, the automation line of operation S20 is operated as before, and when the quantity is changed on the manufacturing line, operation S22 is performed.

Here, the change in the quantity of the manufacturing line may mean that the number of tasks allocated to the transfer units 500 has changed (or when the difference in the number of times of the task that have changed exceeds a threshold value). For example, the change in the quantity of the manufacturing line may mean that the number of times the container 20 is transferred from apparatus A among the substrate processing apparatuses 10 to apparatus B among the substrate processing apparatuses 10 was previously 300 times over three days, but as a result of checking again in operation S21 after the preset cycle has passed, the number of times the container 20 is transferred from apparatus A among the substrate processing apparatuses 10 to apparatus B among the substrate processing apparatuses 10 was reduced to 100 times over three days.

It can be assumed that the user has changed the type, specification, and production per unit time of the semiconductor device to be manufactured through the substrate processing apparatuses 10.

When it is confirmed that the quantity of the manufacturing line has been changed, the switching units 350 disposed in the switching zones B may be changed to the constant driving mode through operation S22.

Then, through the operation S23, the switching units 350 may be operated in the constant driving mode for a cycle preset by the user. The preset cycle may be the same cycle as the cycle set in operation S21. For the preset cycle, a direction statistical value that is traveling information about usage (utilization) for each direction of the switching unit 350 while the transfer unit 500 enters and travels in the switching unit 350 may be collected. The collection of the direction statistical value may be performed by the control system 700. That is, in operation S23, the direction statistical value that is information on usage for each direction of the transfer unit 500 for the switching unit 350 may be collected for a predetermined period of time.

When the preset cycle ends, the control system 700 may control the direction of the switching unit 350 through operation S24. In this case, the control system 700 may control the direction of the switching unit 350 in a direction in which usage is large for each switching unit 350 based on the direction statistical value.

In addition, the automation line may be operated again for the preset cycle through operation S20. In this case, for the preset cycle, the direction of the switching unit 350 controlled in operation S24 may be fixed and used.

It may be most reasonable for the sensor 600 to always change the direction of the switching unit 350 each time as in the above-described [constant driving mode], but when the direction of the switching unit 350 is repeatedly changed frequently, the switching unit 350 may fail. In addition, it may be difficult to change the direction of the switching unit 350 very quickly, and in this case, the switching time required for the switching unit 350 to change the direction becomes the time for which the transfer unit 500 cannot utilize the switching unit 350. That is, in some cases, the [constant driving mode] may result in lowering transfer efficiency in operating the automation line. Accordingly, the present invention checks whether the quantity of the manufacturing line is changed at each cycle preset by the user. At this time, the occurrence of the quantity change means that the type or number of times of the task allocated to the transfer unit 500 has also changed.

That is, the direction of the switching unit 350 may be maintained until it is confirmed that the quantity of the manufacturing line is changed, and when it is confirmed that the quantity of the manufacturing line is changed, the direction of the switching unit 350 may be set in advance by switching the operation mode to the constant driving mode so as to reflect the changed matter, collecting the direction statistical value, and reflecting the collected direction statistical value.

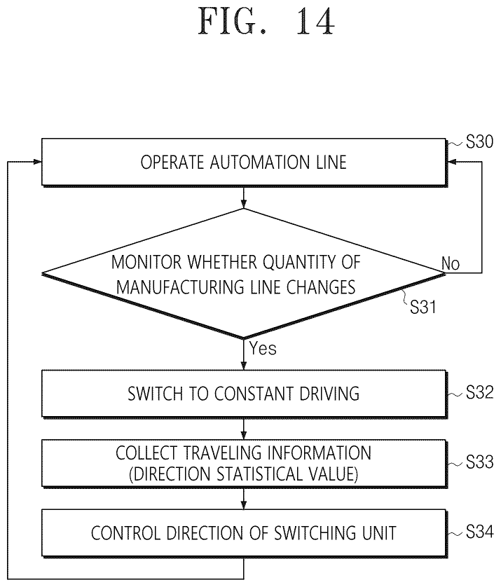

FIG. 14 is a flowchart illustrating a third exemplary embodiment of the control method of FIG. 11.

Referring to FIGS. 1, 7, and 14, in the third exemplary embodiment of the present invention, a case where the switching unit 350 is operated in the [fixed mode] will be described as an example. Operations S30, S32, S33, and S34 included in the control method according to the third exemplary embodiment are substantially the same as operations S20, S22, S23, and S24 described above, and thus repeated explanations will be omitted and differences from the second exemplary embodiment will be mainly described below.

In operation S31 according to the third exemplary embodiment, whether the quantity of the manufacturing line is changed is monitored. In operation S21, whether the quantity of the manufacturing line is changed is checked for each cycle preset by the user, but in operation S31, whether the quantity of the manufacturing line is changed is continuously monitored regardless of this cycle. For example, it is continuously checked whether the quantity per hour is changed, and even if the quantity per hour remains the same or changes, if the quantity per hour changes within the threshold value, operation S31 is continued.

Alternatively, when whether the quantity per hour is changed, the switching units 350 may be switched to the constant driving mode through operation S32. Thereafter, in operation S33, a direction statistical value, which is information on usage for each direction of the transfer unit 500 for the switching unit 350, may be collected for a predetermined period of time.

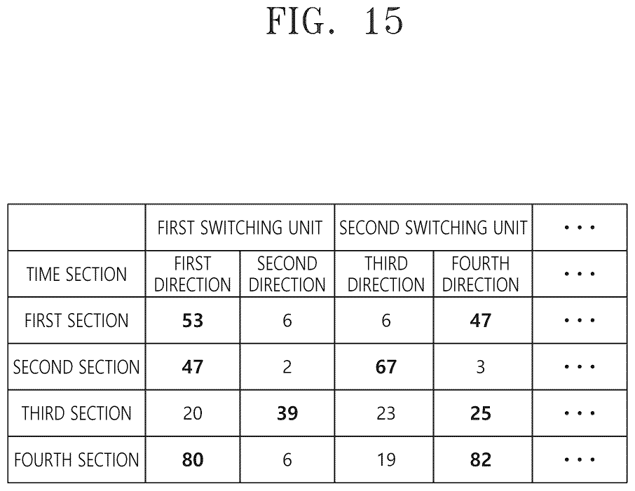

FIG. 15 is a flowchart illustrating a fourth exemplary embodiment of the control method of FIG. 11. Referring to FIGS. 1, 7, and 15, in the fourth exemplary embodiment of the present invention, a case where the switching unit 350 is operated in a [pattern analysis mode] will be described as an example.

In the fourth exemplary embodiment, a direction statistical value on usage for each direction of the switching unit 350 may be collected through the constant driving mode. In addition, by grasping the cycle of the transfer pattern, the usage for each specific time zone may be determined.

For example, the time section may be divided into a first section (e.g., 0:00 to 6:00), a second section (e.g., 6:00 to 12:00), a third section (e.g., 12:00 to 18:00), and a fourth section (e.g., 18:00 to 24:00), and for each time section, the direction of the switching unit 350 may be set in a direction with more usage for each direction based on the direction statistical value on the usage for each direction of the switching unit 350.

However, the time section may not be separately set as described above. For example, when the control system 700 collects a direction statistical value for each switching unit 350, the time section may be divided around an inflection point (e.g., a time point when the usage in a first direction is maintained at a certain level and then decreased), and the direction of the switching unit 350 may be set in accordance with the corresponding time section.

The first to fourth exemplary embodiments described above may be applied alone or in a mixture. For example, the switching unit 350 disposed in the first switching zone B1 may be used in the constant driving mode, the switching unit 350 disposed in the second switching zone B2 may be used in the fixed mode, and the switching unit 350 disposed in the third switching zone B3 may be used in the pattern analysis mode.

For example, when the direction statistical value is checked, when the difference in usage for each direction of the switching unit 350 is equal to or smaller than a set value in a number of time sections equal to or greater than a set number, the constant driving mode may be applied. When the difference in usage for each direction of the switching unit 350 exceeds the set value in a number of time sections equal to or greater than the set number, the fixed mode may be applied. When the difference in usage for each direction of the switching unit 350 exceeds the set value in a number of time sections equal to or less than the set number, the pattern analysis mode may be applied.

The foregoing detailed description illustrates the present invention. Further, the above content shows and describes the exemplary embodiment of the present invention, and the present invention may be used in various other combinations, modifications, and environments. That is, the foregoing content may be modified or corrected within the scope of the concept of the invention disclosed in the present specification, the scope equivalent to that of the invention, and/or the scope of the skill or knowledge in the art. The foregoing exemplary embodiment describes the best state for implementing the technical spirit of the present invention, and various changes required in specific application fields and uses of the present invention are possible. Accordingly, the detailed description of the invention above is not intended to limit the invention to the disclosed exemplary embodiment. Further, the accompanying claims should be construed to include other exemplary embodiments as well.

1. A method of controlling a transfer system that transfers an article within a manufacturing line, the method comprising:
collecting traveling information obtained while a transfer unit travels along a rail installed on the manufacturing line; and
based on the traveling information, controlling a direction of at least one switching unit included in the rail, in which the switching unit switches a lane on which the transfer unit travels.

2. The method of claim 1, wherein the traveling information is collected by the sensor, and is information about whether the transfer unit is to enter a switching zone where the switching unit is provided and is entering the switching zone, and,
the controlling of the direction of the switching unit includes changing the direction of the switching unit prior to a set time before the transfer unit enters the switching unit.

3. The method of claim 2, wherein a switching time required for the switching unit to change the direction is shorter than the set time.

4. The method of claim 2, further comprising:
allocating a task to the transfer unit; and
deriving a traveling path of the transfer unit based on the allocated task and checking whether the switching unit exists on the derived traveling path.

5. The method of claim 4, wherein the controlling of the direction of the switching unit includes presetting the direction of the switching unit according to the traveling path when the switching unit exists on the traveling path.

6. The method of claim 5, wherein the collecting of the traveling information is performed after the presetting of the direction of the switching unit and before the changing of the direction of the switching unit.

7. The method of claim 4, further comprising:
when the direction is not changed in the changing of the direction of the switching unit, re-searching a new traveling path to enable the task of the transfer unit to be performed.

8. The method of claim 1, wherein the traveling information is collected by a control system that controls the transfer unit, and is information on a direction statistical value, which are usage by the transfer unit for each direction of the transfer unit for a certain period of time while the switching unit operates in a constant driving mode.

9. The method of claim 8, further comprising:
controlling the direction of the switching unit based on the direction statistical value,
wherein the direction of the switching unit is maintained until it is confirmed that a quantity of the manufacturing line is changed.

10. The method of claim 8, wherein the switching to the constant driving mode for collecting the direction statistical value takes place when the control system checks whether a quantity of the manufacturing line changes every preset cycle and the quantity is changed.

11. The method of claim 8, wherein the switching to the constant driving mode for collecting the direction statistical value takes place when the control system monitors whether a quantity of the manufacturing line changes, and the quantity is changed.

12. The method of claim 8, wherein the direction statistical value is collected for each time section, and when a usage difference for each direction exceeds a set value in each time section, the direction of the switching unit is changed to a direction with more usage.

13. The method of claim 12, wherein the time section is divided into a time section preset by a user.

14. The method of claim 12, wherein the time section is divided centered on an inflection point at which usage for each direction changes based on the direction statistical value.

15. The method of claim 1, wherein the switching unit is provided in plural,
a first switching unit among the switching units operates in a constant driving mode in which the direction is always switched based on whether the transfer unit enters a first switching zone, in which the first switching unit is provided, collected by the sensor, and a task allocated to the transfer unit,
a second switching unit among the switching units operates in a fixed mode in which the direction is fixed for a certain period of time based on a statistical value for each direction of the second switching unit collected by the control system controlling the transfer unit, and
a third switching unit among the switching units operates in a pattern analysis mode in which the direction is changed for each time section based on a statistical value for each direction of the third switching unit collected by the control system.

16-20. (canceled)
